(19) United States
(12) Patent Application Publication
(10) Pub. No.: US 2025/0300821 A1
(43) Pub. Date: Sep. 25, 2025

(54) ENCRYPTION OF SCAN CHAIN OUTPUT

(71) Applicant: Advanced Micro Devices, Inc., Santa Clara, CA (US)

(72) Inventors: Nehal Patel, Santa Clara, CA (US); Piyush Kumar Srivastava, Bangalore (IN); Paul Simoncic, Reston, VA (US); William A Moyes, Austin, TX (US); Carlos Vallin, Austin, TX (US)

(73) Assignee: Advanced Micro Devices, Inc., Santa Clara, CA (US)

(21) Appl. No.: 18/611,067

(22) Filed: Mar. 20, 2024

(51) Int. Cl. H04L 9/08; G01R 31/3185

(52) U.S. Cl. CPC H04L 9/0861; G01R 31/318536; H04L 9/0825

(57) ABSTRACT

Scan chain data of a system-on-chip (SoC) is protected from unauthorized access by an encryption circuit disposed on the SoC. A test access port (TAP) is coupled to the scan chain and is configured to shift data through the scan chain. The encryption circuit is coupled to the TAP and is configured to encrypt the data into encrypted data for output from the SoC.

### TECHNICAL FIELD

The disclosure generally relates to protecting confidential data in and protecting the device during scan chain output.

### BACKGROUND

Diagnosing the source of an error in complex system-on-chip (SoC) devices (or simply “SoCs”) when deployed in the field creates a number of challenges. For a manufacturer to diagnose the source of an error, it may be difficult or impossible to reproduce the error in the test environment of the manufacturer. Therefore, it is crucial to acquire diagnostic data when the error occurs in the field.

Most SoCs are designed to include scan testing capabilities. A scan chain includes serially connected flip-flops into which test data can be shifted-in and response data can be shifted-out. A scan dump captures the state of the entire scan chain, which enables a designer to analyze the state of proprietary logic cores, system configuration, and the states of buffers in the system bus, for example. However, permitting an end-user unfettered access to a scan dump from the device may expose confidential information of the manufacturer. Note that in this description, “manufacturer” refers to the party responsible for diagnosing the problem in the SoC. Thus, a fabless chip company may be viewed as the manufacturer, even though some other company fabricated and assembled the SoC. Also in this description, “SoC” can also refer to a system-in-package (SiP) or integrated circuits (ICs) in general.

### BRIEF DESCRIPTION OF THE DRAWINGS

Various aspects and features of the circuits and methods will become apparent upon review of the following detailed description and upon reference to the drawings in which:

FIG. 1 illustrates in block diagram form a data processing system that can be configured to include integrated circuitry that can securely produce encrypted scan dumps;

FIG. 2 shows a flowchart of a process in which an encrypted scan dump is obtained, and the encrypted scan dump is communicated to a manufacturer for analysis;

FIG. 3 shows a block diagram of an exemplary implementation of scan dump logic that securely produces an encrypted scan dump; and

FIG. 4 shows a flowchart of a process by which scan logic securely produces an encrypted scan dump.

### DETAILED DESCRIPTION

In the following description, numerous specific details are set forth to describe specific examples presented herein. It should be apparent, however, to one skilled in the art, that one or more other examples and/or variations of these examples, all of which are non-limiting, may be practiced without all the specific details given below. In other instances, well known features have not been described in detail so as not to obscure the description of the examples herein. For ease of illustration, the same reference numerals may be used in different diagrams to refer to the same elements or additional instances of the same element.

Current approaches to overcome these challenges, though workable, can be cumbersome and create security risks. According to one approach, by a default configuration the manufacturer disables in-field access to the scan interface for obtaining a scan dump. To enable in-field access to the scan interface to obtain a scan dump, personnel in the field must connect to manufacturer's server, obtain a security key(s), and apply the key. This approach is cumbersome and may be infeasible for some systems. Once the scan interface is enabled on the SoC, scan data output from the SoC is not encrypted, and the SoC may be vulnerable to attacks.

The circuits and methods disclosed herein allow an end-user to securely collect debug data at the point of failure without coordinating with the manufacturer. The end user can choose the time at which the encrypted scan dump is provided to the manufacturer. The approaches simplify the logistics of providing a scan dump to the manufacturer and make it more likely the end user will have meaningful data when contacting the manufacturer for assistance.

The end user need not wait for the manufacturer to provide keys to begin the scan dump, and the end user can fully control the scan dump. When a failure is recognized, the end user can stop the SoC, initiate the scan dump process, store the encrypted scan dump on retentive storage, and restart the SoC. The encrypted scan dump can then be sent to the manufacturer for debugging.

According to the disclosed circuits and methods, scan chain data of an SoC is protected for output from the SoC by an encryption circuit that is disposed on the SoC. Prior to output from the SoC, the encryption circuit encrypts the scan chain data so that the scan chain data is accessible only to authorized parties.

According to other features, the scan dump data is encrypted internally by the SoC using an SoC-generated session key, and the session key is encrypted using a manufacturer's public key of a key pair. While the scan dump is being encrypted and output, scan input can be disabled to protect against unauthorized writing to the scan chain. The encrypted scan dump and encrypted session key can then be transmitted by the end-user to the manufacturer for analysis. The manufacturer can decrypt the session key using the manufacturer's private key and then use the decrypted session key to decrypt the encrypted scan dump.

Though the exemplary methods and circuits described herein are described in terms of the IEEE standard 1149.1 Test Access Port (popularly referred to as “JTAG”), the disclosed approaches are not so limited and can be applied to other debugging protocols and associated serial access ports, such as the Serial Wire Debug (SWD), or packetized interfaces such as JTAG over a Universal Serial Bus (USB).

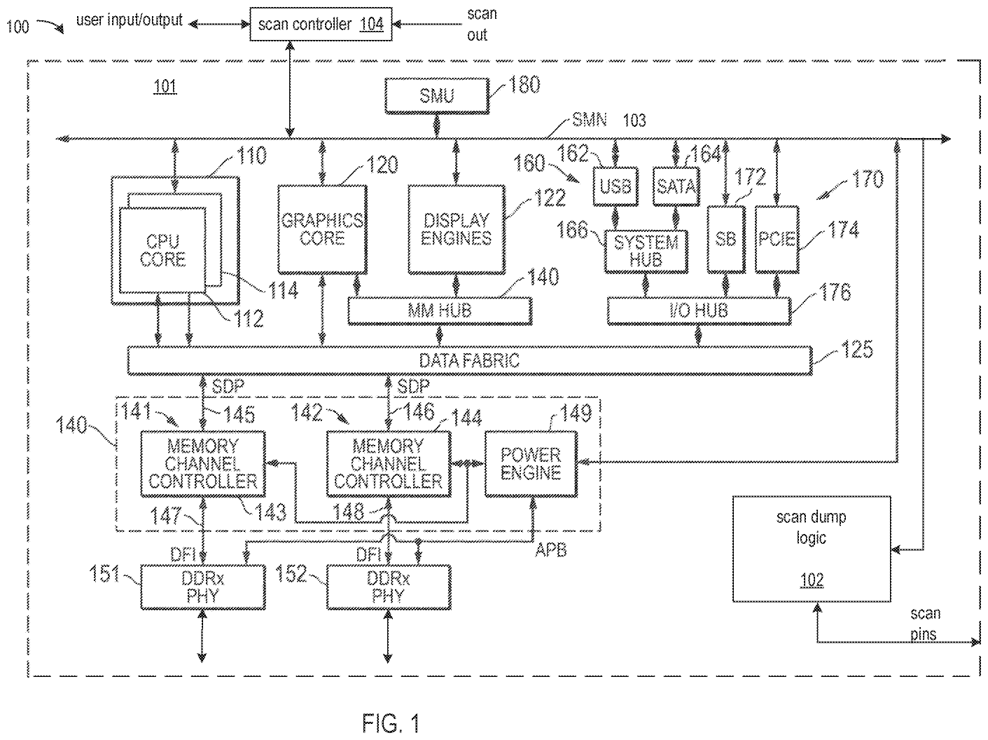

FIG. 1 illustrates in block diagram form a data processing system 100 that can be configured to include integrated circuitry that can securely produce encrypted scan dumps. Data processing system 100 includes an APU 101 and an external scan controller 104. The APU 101 can be an SoC suitable for use as a processor in a host data processing system, and includes generally a central processing unit (CPU) core complex 110, a graphics core 120, a set of display engines 122, a memory management hub 140, a data fabric 125, a set of peripheral controllers 160, a set of peripheral bus controllers 170, and a system management unit (SMU) 180. The exemplary data processing system includes many components, which may or may not be present in different architectures directed to different computing environments.

The scan dump logic 102, for purposes of illustration only, includes the scan chains, scan controller, test access port (TAP) and other logic for securely producing an encrypted scan dump. The scan dump logic is coupled to external pins of the APU 101 for scan input and scan output, as well as to the system management network (SMN) 103. While the scan dump logic is generating and outputting an encrypted scan dump, the scan dump logic disables input to the scan chains.

The scan dump logic additionally includes a key-generation circuit that generates a symmetric session key, which is used by encryption circuitry to encrypt the scan dump. The session key can be generated each time the SoC restarts, or in response to a trigger signal provided at times other than a restart. To protect the session key, the scan dump logic includes additional encryption circuitry that uses the public key of the manufacturer for asymmetric encryption of the session key.

External scan controller 104 can take alternative forms for providing control and monitoring capabilities. For example, the external scan controller can take the form of an external management controller such as a baseboard management controller, a SmartNIC, a Bridge IC, a Satellite Management Controller, an Embedded Controller, etc. The external scan controller can implemented as a custom ASIC, FPGA, or a dedicated debug probe. External scan controller 104 monitors the state of APU 101 and various other components (not shown separately) of data processing system 100 by receiving error reports and monitoring status registers and sensors. External scan controller 104 is connected via the SMN 103 to system communication busses such as the depicted peripheral component interconnect express (PCIe) bus and universal serial bus (USB), and may also monitor registers in various system components via an inter-integrated circuit bus to poll for error reports. External access to functions of the external scan controller is provided for remote monitoring and control, typically through a dedicated network interface or a connection to the network interface of data processing system 100.

External scan controller 104 is also coupled to the external pin of the APU 101 for receiving scan output. In response to user input, the external scan controller can direct the scan dump logic 102 to initiate a scan dump. The external scan controller receives the encrypted scan dump from the external pin of the APU.

CPU core complex 110 includes a CPU core 112 and a CPU core 114. In this example, CPU core complex 110 includes two CPU cores, but in other embodiments CPU core complex 110 can include an arbitrary number of CPU cores. Each of CPU cores 112 and 114 is bidirectionally connected to the SMN, which forms a control fabric, and to data fabric 125, and is capable of providing memory access requests to data fabric 125. Each of CPU cores 112 and 114 may be unitary cores, or may further be a core complex with two or more unitary cores sharing certain resources such as caches.

Graphics core 120 is a high performance graphics processing unit (GPU) capable of performing graphics operations such as vertex processing, fragment processing, shading, texture blending, and the like in a highly integrated and parallel fashion. Graphics core 120 is bidirectionally connected to the SMN and to data fabric 125, and is capable of providing memory access requests to data fabric 125. In this regard, APU 101 may either support a unified memory architecture in which CPU core complex 110 and graphics core 120 share the same memory space, or a memory architecture in which CPU core complex 110 and graphics core 120 share a portion of the memory space, while graphics core 120 also uses a private graphics memory not accessible by CPU core complex 110.

Display engines 122 render and rasterize objects generated by graphics core 120 for display on a monitor. Graphics core 120 and display engines 122 are bidirectionally connected to a common memory management hub 140 for uniform translation into appropriate addresses in a memory system (not shown), and memory management hub 140 is bidirectionally connected to data fabric 125 for generating such memory accesses and receiving read data returned from the memory system. The memory system can include sets of dual inline memory modules (DIMMs), for example.

Data fabric 125 includes a crossbar switch for routing memory access requests and memory responses between any memory accessing agent and memory management hub 140. It also includes a system memory map, defined by basic input/output system (BIOS), for determining destinations of memory accesses based on the system configuration, as well as buffers for each virtual connection.

Peripheral controllers 160 include a universal serial bus (USB) controller 162 and a Serial Advanced Technology Attachment (SATA) interface controller 164, each of which is bidirectionally connected to a system hub 166 and to the SMN bus. These two controllers are merely exemplary of peripheral controllers that may be used in APU 101.

Peripheral bus controllers 170 include a system controller or “Southbridge” (SB) 172 and a Peripheral Component Interconnect Express (PCIe) controller 174, each of which is bidirectionally connected to an input/output (I/O) hub 176 and to the SMN bus. I/O hub 176 is also bidirectionally connected to system hub 166 and to data fabric 125. Thus, for example a CPU core can program registers in USB controller 162, SATA interface controller 164, SB 172, or PCIe controller 174 through accesses that data fabric 125 routes through I/O hub 176. Software and firmware for APU 101 are stored in a system data drive or system BIOS memory (not shown) which can be any of a variety of non-volatile memory types, such as read-only memory (ROM), flash electrically erasable programmable ROM (EEPROM), and the like. Typically, the BIOS memory is accessed through the PCIe bus, and the system data drive through the SATA interface.

SMU 180 is a local controller that controls the operation of the resources on APU 101 and synchronizes communication among them. SMU 180 manages power-up sequencing of the various processors on APU 101 and controls multiple off-chip devices via reset, enable and other signals. SMU 180 includes one or more clock sources (not shown), such as a phase locked loop (PLL), to provide clock signals for each of the components of APU 101. SMU 180 also manages power for the various processors and other functional blocks, and may receive measured power consumption values from CPU cores 112 and 114 and graphics core 120 to determine appropriate power states.

Memory management hub 140 and its associated physical interfaces (PHYs) 151 and 152 are integrated with APU 101 in this embodiment. Memory management hub 140 includes memory channels 141 and 142 and a power engine 149. Memory channel 141 includes a host interface 145, a memory channel controller 143, and a physical interface 147. Host interface 145 bidirectionally connects memory channel controller 143 to data fabric 125 over a serial presence detect link (SDP). Physical interface 147 bidirectionally connects memory channel controller 143 to PHY 151, and conforms to the DDR PHY Interface (DFI) Specification. Memory channel 142 includes a host interface 146, a memory channel controller 144, and a physical interface 148. Host interface 146 bidirectionally connects memory channel controller 144 to data fabric 125 over another SDP. Physical interface 148 bidirectionally connects memory channel controller 144 to PHY 152, and conforms to the DFI Specification. Power engine 149 is bidirectionally connected to SMU 180 over the SMN bus, to PHYs 151 and 152 over the APB, and is also bidirectionally connected to memory channel controllers 143 and 144. PHY 151 has a bidirectional connection to memory channel 131. PHY 152 has a bidirectional connection memory channel 133.

Memory management hub 140 is an instantiation of a memory controller having two memory channel controllers and uses a shared power engine 149 to control operation of both memory channel controller 143 and memory channel controller 144 in a manner that will be described further below. Each of memory channels 141 and 142 can connect to state-of-the-art DDR memories such as DDR version four (DDR4), low power DDR4 (LPDDR4), graphics DDR version five (gDDR5), and high bandwidth memory (HBM), and can be adapted for future memory technologies. These memories provide high bus bandwidth and high speed operation. At the same time, they also provide low power modes to save power for battery-powered applications such as laptop computers, and also provide built-in thermal monitoring.

APU 101 operates as the central processing unit (CPU) of a host data processing system and provides various buses and interfaces useful in modern computer systems. These interfaces include two double data rate (DDRx) memory channels, a PCIe root complex for connection to a PCIe link, a USB controller for connection to a USB network, and an interface to a SATA mass storage device.

APU 101 also implements various system monitoring and power saving functions. In particular one system monitoring function is thermal monitoring. For example, if APU 101 becomes hot, then SMU 180 can reduce the frequency and voltage of CPU cores 112 and 114 and/or graphics core 120. If APU 101 becomes too hot, then it can be shut down entirely. Thermal events can also be received from external sensors by SMU 180 via the SMN bus, and SMU 180 can reduce the clock frequency and/or power supply voltage in response.

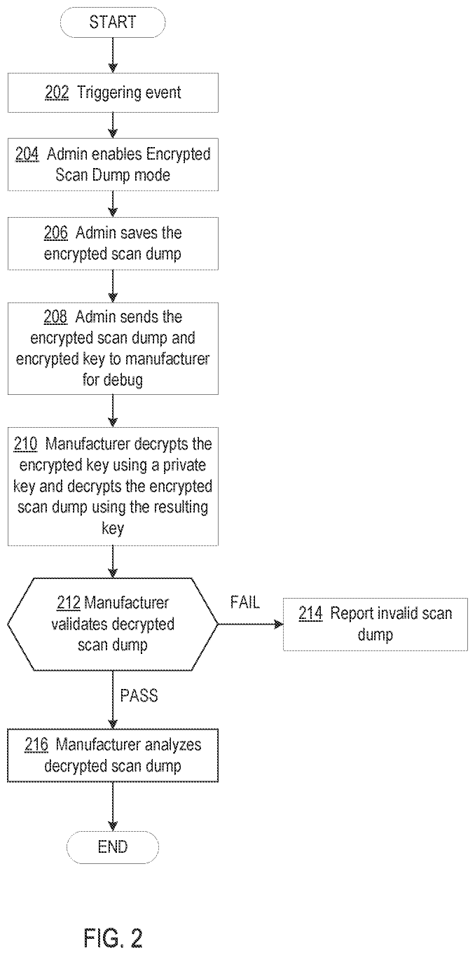

FIG. 2 shows a flowchart of a process in which an encrypted scan dump is obtained in response to an event that merits obtaining a scan dump. Examples of triggering events can include SoC hardware failures, failures of software executing on the SoC, environmental operating conditions, performance metrics, etc. At block 202, the occurrence of a triggering event indicates the need to obtain a scan dump. As an automated response to the event trigger, or at a time convenient for the end user (e.g., system administrator), encrypted scan dump (ESD) mode can be enabled on the SoC, either automatically or manually through an interface of the external scan controller at block 204. In response, the scan dump logic disables scan input and begins encrypting the scan chain data using an internally-generated session key and outputting the scan chain data. The scan dump logic also encrypts the session key using the manufacturer's public key, which can be preconfigured in the SoC, and outputs the encrypted session key.

At block 206, the output encrypted session key and encrypted scan dump can be stored in a file in retentive storage accessible to the end user, either automatically or at the direction of the end user. At block 208, the end user can send the encrypted session key and encrypted scan dump by electronic file transfer to the manufacturer for debugging.

The manufacturer at block 210 decrypts the encrypted session key using the manufacturer's private key, and then decrypts the encrypted scan dump using the decrypted session key. At decision block 212, the manufacturer can validate the scan dump. In response to the validation failing, at block 214 the manufacturer can report the failure to the end-user. Otherwise, at block 216 the manufacturer can analyze the scan dump to find the source of the application failure.

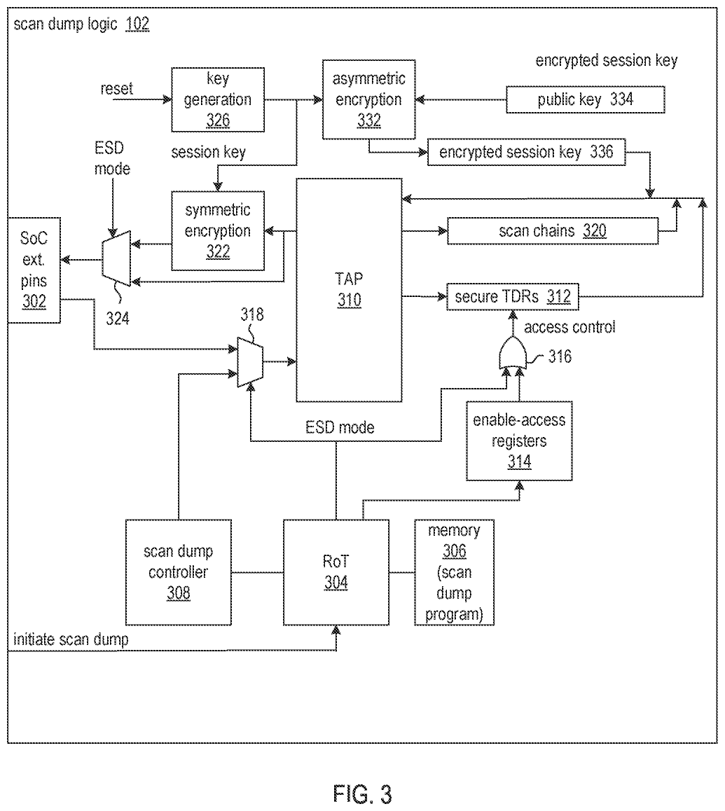

FIG. 3 shows a block diagram of an exemplary implementation of scan dump logic 102 that securely produces an encrypted scan dump. The scan dump logic can be coupled to an external scan controller through SoC external pins 302 and through Root-of-Trust circuitry (or simply “ROT”) 304, which can be a trusted, fixed-hardware module of a cryptographic system of the SoC. An encrypted scan dump can be initiated by signaling the RoT from the external scan controller. For example, an end-user can instruct the external scan controller to send a message to a mailbox associated with the RoT. In response to the message, the ROT loads a scan dump program from memory circuit 306 and asserts an encrypted-scan-dump (ESD) mode signal. The memory circuit can be a local ROM, SRAM, or DRAM. In a ROM implementation, the ROM can be preconfigured with the scan dump program sequence, and SRAM and DRAM can be configured with the scan dump program through secure firmware in those implementations.

In executing the scan dump program, the ROT signals the scan controller 308 to initiate control of the test access port (TAP) 310 for shifting data through the scan chains 320. The ROT signals the scan controller to configure the secure test data registers (TDRs) 312 with data that places the SoC in scan dump mode. The sequence of control signals provided by the scan controller to the TAP is the same as the sequence normally input to the TAP from an off-SoC scan controller to produce a scan dump.

Scan access to the secure TDRs 312 can be individually disabled by default in a production SoC by the enable-access registers 314. To perform a secure scan dump, however, access to certain ones of the TDRs is enabled. For each TDR, an associated OR gate, collectively shown as OR gate 316, and the ESD mode signal can be used to override the default, disabled access as controlled by an associated one of the enable-access registers 314. In response to the ESD mode signal being asserted or an enable access register configured to allow access, access to the associated TDR is enabled allowing configuration by the scan controller 308.

In a departure from prior approaches, while the ESD mode signal is asserted scan output data from the TAP is encrypted and scan input data to the TAP 310 is limited to data from the scan controller, thereby protecting against attacks on the SoC during a scan dump by effectively disabling scan input data from the an external source coupled to the SoC external pins 302. Multiplexer 318 is coupled to an input pin(s) of SoC external pins 302 and to the scan controller 308. In response to the ESD mode signal being asserted, scan input data to the TAP is selected from the scan controller. In response to the ESD mode signal being unasserted, scan input data to the TAP is selected from the SoC external input pin.

Scan output data from the scan chains 320 and TDRs 312 is provided as scan output data by TAP 310. The scan output data can be encrypted by encryption circuit 322 and selected by multiplexer 324 for output on an output pin of SoC external pins 302 in response to the ESD mode signal being asserted. In response to the ESD mode signal not being asserted, multiplexer 324 selects the unencrypted scan output data from TAP 310.

The encryption circuit 322 encrypts the scan output data using a session key, which is generated by key generation circuit 326. According to an exemplary approach, the encryption circuit implements the Advanced Encryption Standard (AES). Alternative symmetric encryption algorithms may be implemented based on SoC requirements. The key generation circuit can generate a new session key each time the SoC is reset or booted using recognized algorithms implemented on hardwired circuitry, programmable logic, a microprocessor, or some combination thereof.

In order protect the session key for communication to the manufacturer, the session key is encrypted using asymmetric encryption. Asymmetric encryption circuit 332 is configured to encrypt the session key according to an asymmetric encryption algorithm, such as RSA, ECC, etc. using public key 334, which can be hardwired or configured by eFuses or antifuses prior to delivery of the SoC to an end-user. According to an exemplary approach, the session key is generated and encrypted at SoC-startup time. The encrypted session key can be stored in a secure shift register 336 and shifted as scan output out by TAP 310.

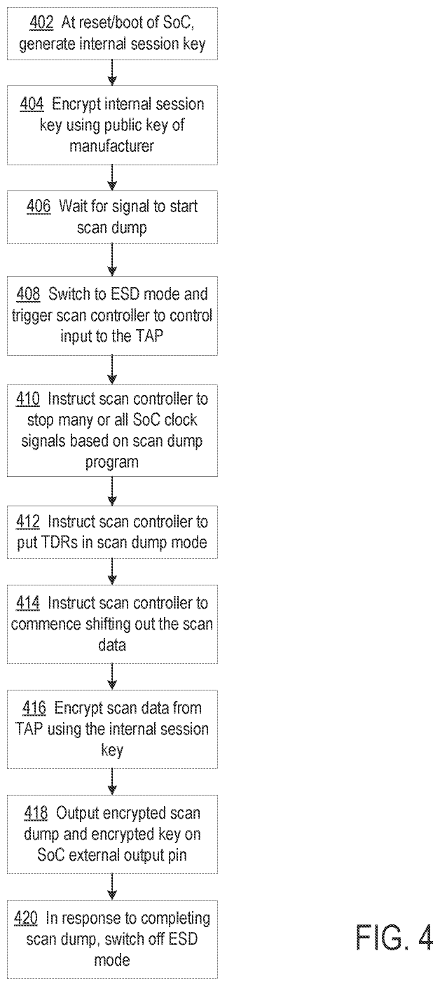

FIG. 4 shows a flowchart of a process by which scan logic securely produces an encrypted scan dump. At block 402, a key-generation circuit integrated with the SoC generates a session key in response to resetting or booting of the SoC. At block 404, the scan dump logic encrypts the session key using the public key of a key pair of the manufacturer and stores the encrypted session key in a secure shift register.

Scan dump logic of the SoC remains inoperative and waits at block 406 until a signal is received, such as from an external scan controller or an internal control circuit, to begin a scan dump. In response to the signal to begin a scan dump, at block 408 the ROT circuit of the SoC switches to ESD mode and triggers the scan controller to provide input to the TAP of the SoC. At block 410, in executing the scan dump program, the RoT instructs the scan controller to stop the many or all SoC clock signals, and configure the TDRs of the SoC to enable scan dump mode at block 412.

At block 414, in executing the scan dump program the ROT instructs the scan controller to commence the shifting out of data from the scan chains and TDRs. The encryption circuit of the scan dump logic encrypts the scan output data at block 416 using the internally generated session key.

The encrypted scan dump and encrypted session key are output on an external output pin of the SoC at block 418 as the data is shifted through the TAP. Once the scan dump is complete, the ROT switches off the ESD mode at block 420.

Various logic may be implemented as circuitry to carry out one or more of the operations and activities described herein and/or shown in the figures. In these contexts, a circuit or circuitry may be referred to using terms such as “logic,” “module,” “engine,” “generator,” or “block.” It should be understood that elements labeled by these terms are all circuits that carry out one or more of the operations/activities. In certain implementations, a programmable circuit is one or more computer circuits programmed to execute a set (or sets) of instructions stored in a ROM or RAM and/or operate according to configuration data stored in a configuration memory.

Though aspects and features may in some cases be described in individual figures, it will be appreciated that features from one figure can be combined with features of another figure even though the combination is not explicitly shown or explicitly described as a combination.

The circuits and methods are thought to be applicable to a variety of systems for protecting scan output data. Other aspects and features will be apparent to those skilled in the art from consideration of the specification. The circuits and methods may be implemented as one or more microprocessors configured to execute software, as an application specific integrated circuit (ASIC), or as programmable logic. It is intended that the specification and drawings be considered as examples only, with a true scope of the invention being indicated by the following claims.

What is claimed is:

1. A circuit comprising:
a scan chain disposed on a system-on-chip (SoC);
a test access port (TAP) coupled to the scan chain and configured to shift data through the scan chain; and
a first encryption circuit coupled to the TAP disposed on the SoC and configured to encrypt the data into encrypted data for output from the SoC.

2. The circuit of claim 1, further comprising a control circuit configured to selectively disable input of scan data from an external source.

3. The circuit of claim 1, further comprising:
a key-generation circuit coupled to the first encryption circuit, wherein the key-generation circuit is configured to generate a session key for the first encryption circuit to encrypt the data.

4. The circuit of claim 3, wherein the first encryption circuit implements a symmetric encryption algorithm to encrypt the data.

5. The circuit of claim 3, further comprising a second encryption circuit configured to encrypt the session key for output from the SoC.

6. The circuit of claim 5, wherein the second encryption circuit implements an asymmetric encryption algorithm to encrypt the session key.

7. The circuit of claim 6, further comprising circuitry configured with a public key for the asymmetric encryption algorithm.

8. The circuit of claim 3, wherein the key-generation circuit is configured to generate a different session key in response to a reset of circuitry on the SoC.

9. The circuit of claim 1, further comprising
root-of-trust (ROT) circuitry coupled to the TAP and configured to signal encrypted-scan-dump-mode-on in response to an instruction from an external scan controller;
and
a control circuit coupled to the ROT circuitry and configured to disable input of scan data from an external source in response to the signaled encrypted-scan-dump-mode-on.

10. The circuit of claim 9, further comprising:
an internal scan controller coupled to the ROT circuitry and to the control circuit, wherein the internal scan controller is configured to provide scan control signals to the TAP to initiate shifting the data through the scan chain in response to the ROT circuitry; and
wherein the control circuit is configured to select scan control signals from the internal scan controller instead of input from the external source in response to the signaled encrypted-scan-dump-mode-on.

11. The circuit of claim 9, further comprising:
a secure test data register (TDR) coupled to the scan chain
wherein the control circuit is configured to enable access to the TDR in response to the signaled encrypted-scan-dump-mode-on, and the first encryption circuit is configured to encrypt data from the TDR register for output from the SoC.

12. A method comprising:
shifting data through a scan chain by a test access port (TAP) coupled to the scan chain; and
encrypting the data into encrypted data for output from the SoC by a first encryption circuit disposed in the SoC.

13. The method of claim 12, further comprising selectively disabling input of scan data from an external source by a control circuit.

14. The method of claim 12, further comprising generating a session key by a key-generation circuit for the first encryption circuit to encrypt the data.

15. The method of claim 14, wherein encrypting includes performing a symmetric encryption algorithm to encrypt the data.

16. The method of claim 14, further comprising encrypting the session key for output from the SoC by a second encryption circuit.

17. The method of claim 16, wherein encrypting by the second encryption circuit includes performing an asymmetric encryption algorithm to encrypt the session key.

18. The method of claim 17, further comprising providing a public key configured on the SoC to the second encryption circuit for performing the asymmetric encryption algorithm.

19. The method of claim 14, further comprising generating a different session key in response to a reset of circuitry on the SoC by the key-generation circuit.

20. The method of claim 12, further comprising:
signaling encrypted-scan-dump-mode-on by root-of-trust (ROT) circuitry in response to an instruction from an external scan controller;
disabling input of scan data from an external source of the SoC in response to the signaled encrypted-scan-dump-mode-on by a control circuit coupled to the ROT circuitry;
providing scan control signals by an internal scan controller to the TAP to initiate shifting the data through the scan chain in response the ROT circuitry; and
selecting scan control signals from the internal scan controller instead of input from the external source by the control circuit in response to the signaled encrypted-scan-dump-mode-on.
